(19) United States
(12) Patent Application Publication
(10) Pub. No.: US 2014/0294023 A1
(43) Pub. Date: Oct. 2, 2014

(54) METHOD AND DEVICE FOR SYNCHRONIZING AN APPARATUS CONNECTED TO A COMMUNICATIONS NETWORK

(71) Applicant: Alstom Technology Ltd., Baden (CH)

(72) Inventors: Frédéric Leconte, Amberieux en Dombes (FR); Jean Luc Rayon, Montanay (FR); Antoine Garcia, Trevignin (FR)

(21) Appl. No.: 14/351,244

(22) PCT Filed: Oct. 16, 2012
(86) PCT No.: PCT/EP2012/070450

§ 371 Date: Apr. 11, 2014

(30) Foreign Application Priority Data
Oct. 17, 2011 (FR) 11 59345

(51) Int. Cl. H04J 3/06; H04L 29/08

(52) U.S. Cl. CPC H04J 3/0658; H04L 67/12
USPC 370/503

(57) ABSTRACT

A method of synchronizing an equipment unit (200) connected to a communications network (110), the equipment unit being connected to an electrical power supply network (120) providing at least one alternating current power supply voltage (121), the method including the steps of measuring a time difference between the power supply voltage and a synchronization voltage (131), computing a synchronization value, communicating the synchronization value to the equipment unit, the equipment unit detecting the power supply voltage passing through the given state, and synchronizing the equipment unit substantially simultaneously with detecting the supply voltage passing through the given state from the synchronization value. The invention also relates to a synchronization device (300) and a synchronization module (400) used in the synchronization method.

### TECHNICAL FIELD

The invention relates to the field of synchronizing an equipment unit relative to a synchronization signal.

Modern industrial installations generally include a large number of equipment units that have to function together to effect successive and perfectly coordinated production steps. As a result of this the equipment units equipping such industrial installations must be synchronized accurately and regularly.

This problem is also relevant to safety equipment units of the same type of installation. Safety equipment units are generally adapted to monitor parameters of the installation synchronously to enable comparison of the monitored parameters and to determine whether the installation is still operating under predefined safety conditions. To enable comparison of the parameters monitored by different safety equipment units, it is therefore necessary for the safety equipment units to be perfectly synchronized with one another.

The invention is aimed more particularly at energy production installations and at monitoring equipment units used to monitor transmission of the energy produced, which equipment units must be synchronized with a synchronization voltage that may not be accessible to said equipment units, its source being several kilometers distant.

The invention relates more precisely to a method of synchronizing equipment connected to a communications network. The invention also relates to a synchronization device used in said synchronization method and to a synchronization module equipping equipment for synchronizing by that synchronization method.

### PRIOR ART

A number of synchronization methods are used at present in industrial installations.

One of these methods is synchronization by radio waves. This method provides each of the equipment units for synchronizing with a radio receiver adapted to receive a synchronization signal from a radio transmitter. That radio transmitter, such as the German DCF-77 radio transmitter or the British MSF-60 radio transmitter, broadcasts at regular intervals a time signal for synchronizing a clock in each of the equipment units for synchronizing.

However, although such methods enable reliable synchronization of equipment units at relatively low cost, they have the drawback of requiring each of the equipment units to be within a coverage area of the radio transmitter. They are therefore not usable in some geographical areas, such as some desert or maritime areas, and are not usable for equipment units situated underground or in environments where there are high levels of electromagnetic interference.

Another method uses a cable timing network such as a network using RS422 or RS485 communications interfaces. In this method the equipment units for synchronizing are connected to a synchronization device via a dedicated timing network. Thus at regular intervals the synchronization device transmits a synchronization signal to all the equipment units via the timing network to synchronize them to a reference clock of the synchronization device.

Although such methods enable reliable synchronization while requiring the installation of equipment of only relatively low cost, they nevertheless have the drawback of requiring the costly installation of a network dedicated exclusively to synchronizing the equipment units.

Another method uses a pre-existing communications network to transmit a synchronization signal, such as an Ethernet protocol communications network to which the equipment units for synchronizing are connected. That method generally relies on a network time protocol (NTP). That method has the advantage of not requiring any real additional cost, since the network used for synchronization is already present and in use for communication between equipment units.

Nevertheless, for reasons of network latency, that method is not able to achieve synchronization accuracy of the order of one microsecond without costly modification of the network equipment.

Another method utilizes a power supply voltage that is common to all the equipment units for synchronizing in order to synchronize them. In that situation, each equipment unit includes either a dedicated synchronization module having an input intended to be connected to said power supply network or a voltage-divider system for reducing the power supply voltage and enabling it to be processed by a low-voltage circuit. In both of those situations, the voltage passing through a given value is used as a reference for synchronizing the equipment units.

Although that synchronization method makes it possible for synchronization to be reliable and accurate, it is not able to synchronize equipment units relative to a synchronization signal that is offset relative to the power supply voltage. Likewise it makes only clock synchronization possible, there being no possibility of transmitting time information.

### SUMMARY OF THE INVENTION

One of the aims of the present invention is to provide a method of synchronizing equipment requiring low installation costs and enabling accurate synchronization with an alternating current synchronization voltage that is not accessible to said equipment for synchronizing.

To this end, the invention provides a method of synchronizing an equipment unit connected to a communications network, the equipment unit being connected to an electrical power supply network providing at least one alternating current power supply voltage, the method including:
a) measuring a time difference between the power supply voltage and an alternating current synchronization voltage, the synchronization voltage having a synchronization frequency;
b) computing a synchronization value from the time difference, said synchronization value corresponding to a computed time difference between the power supply voltage and the synchronization voltage the next time the power supply voltage passes through a given state;
c) communicating the synchronization value to the equipment unit via the communications network;
d) the equipment unit detecting the power supply voltage passing through the given state; and
g) synchronizing the equipment unit substantially simultaneously with detecting the power supply voltage passing through the given state from the synchronization value.

Such methods make it possible with low installation costs to achieve accurate synchronization of the equipment units of an installation relative to a synchronization voltage that is not accessible to said equipment units, the method enabling a pre-existing communications network to be used.

During step c) of communicating the synchronization value, the value of the synchronization frequency may also be communicated to the equipment unit.

Communicating the value of the synchronization frequency in this way makes it possible to synchronize the equipment unit with a synchronization voltage having a frequency that is not predefined and that is not accessible to the equipment unit, and to do so without requiring the equipment unit to be reprogrammed.

In a first variant of the invention, the given state of the power supply voltage may be a given voltage value that is preferably equal to zero volts.

The use of such a given state of the power supply voltage makes it possible to simplify a step of detecting the power supply voltage passing through this same state, thereby reducing the cost of setting up the synchronization method.

In a second variant of the invention, the given state of the power supply voltage may be a predetermined edge of the power supply voltage passing through a given value, the predetermined edge being chosen from the group comprising the rising edge and the falling edge.

With such a given state, the time between the power supply voltage passing through the given state twice is equal to the period of the power supply voltage, thereby optimizing the time available for carrying out the steps a) through c).

Preceding the step a), the method may further include a step a′) of detecting the power supply voltage passing through a second given state, the step a) being carried out substantially simultaneously with the step a′).

The second given state of the power supply voltage may be such that all the steps a) to c) are carried out before the power supply voltage next passes through the given state.

For an appropriate second given state, this step a′) enables the time between the step a) and the step d) to be sufficient for the steps b) and c) to be completed.

The second given state may be substantially the same as the given state.

This second given state makes it possible to maximize the time between the power supply voltage passing through the second given state and through the given state, thereby ensuring that the steps b) and c) are carried out correctly.

The method may further include between the steps d) and g) the steps of:
e) detecting an equipment unit synchronization error; and
f) reporting an equipment desynchronization problem affecting the equipment unit if a synchronization error is detected.

In the context of this optional feature of the invention the expression “synchronization error” means:
non-reception of the synchronization value;
non-reception of the synchronization frequency value if the step c) includes communicating said value;
loss of the communications network;
a problem in detecting the power supply voltage passing through the given state; or
detecting a desynchronization value above a threshold value.

This synchronization error detection enables verification of correct synchronization of an equipment unit when using such a synchronization method.

The step g) may be omitted if a synchronization error is detected.

Accordingly, an equipment unit for which a synchronization error has been detected continues to function with the previous synchronization, thereby avoiding erroneous synchronization of said equipment unit that could compromise the operation of the installation as a whole.

The step e) may include at least the substeps of:
e′) computing for the equipment unit a desynchronization value reflecting the synchronization offset necessary to synchronize said equipment unit during the step e); and
e″) comparing the absolute value of the desynchronization value with the absolute value of a desynchronization threshold value and detecting a desynchronization error affecting the equipment unit if the absolute value of the desynchronization value is greater than the absolute value of the desynchronization threshold value.

This enables an equipment unit synchronization error to be detected.

The communications network may be a communications network using a protocol of the Ethernet type.

Using such a communications network makes it possible to facilitate communication during the step c), which communication may be effected in the form of frames encapsulated according to the Ethernet protocol.

The frequency of the synchronization voltage may be substantially equal to, an integer multiple of, or an integer fraction of the frequency of the power supply voltage, the frequency of the synchronization voltage preferably being equal to the frequency of the power supply voltage.

Such a value of the synchronization voltage frequency makes it possible respectively to detect the value of the time difference and to compare the value of the computed time difference in simplified manner, these operations corresponding, for a synchronization voltage frequency substantially equal to that of the power supply voltage, merely to measuring and computing the time difference between the power supply voltage and the synchronization voltage.

The invention also provides a synchronization device for synchronizing equipment units, said synchronization device being connected to an electrical power supply network providing at least one alternating current power supply voltage, the synchronization device including:
time difference measurement means adapted to measure a time difference between the power supply voltage of the power supply network and a synchronization voltage;
computation means adapted to compute a synchronization value corresponding to a time difference; and
communications means adapted to be connected to a communications network and to communicate a synchronization value via said network.

Such a device enables equipment units connected to a communications network to be synchronized with a synchronization voltage that is not accessible to said equipment units.

The invention further provides a synchronization module for equipping an equipment unit for synchronizing, said synchronization module being connected to an electrical power supply network providing at least one alternating current power supply voltage, the synchronization module including:
means for connecting it to a communications network and adapted to receive a synchronization value;
means for detecting a given state of the power supply voltage; and
means for synchronizing the equipment unit on the basis of the synchronization value communicated via the communications network.

Such a synchronization module enables the equipment unit that it equips to be synchronized with a synchronization voltage that is not accessible to said equipment unit.

The module may further include:
processing means adapted to detect a synchronization error;
signaling means adapted to report an equipment unit desynchronization problem; and
the processing means being further adapted to communicate with said signaling means to report a synchronization problem on detecting a synchronization error.

Such a module makes it possible to report an equipment unit synchronization problem during synchronization of the equipment unit.

### BRIEF DESCRIPTION OF THE DRAWINGS

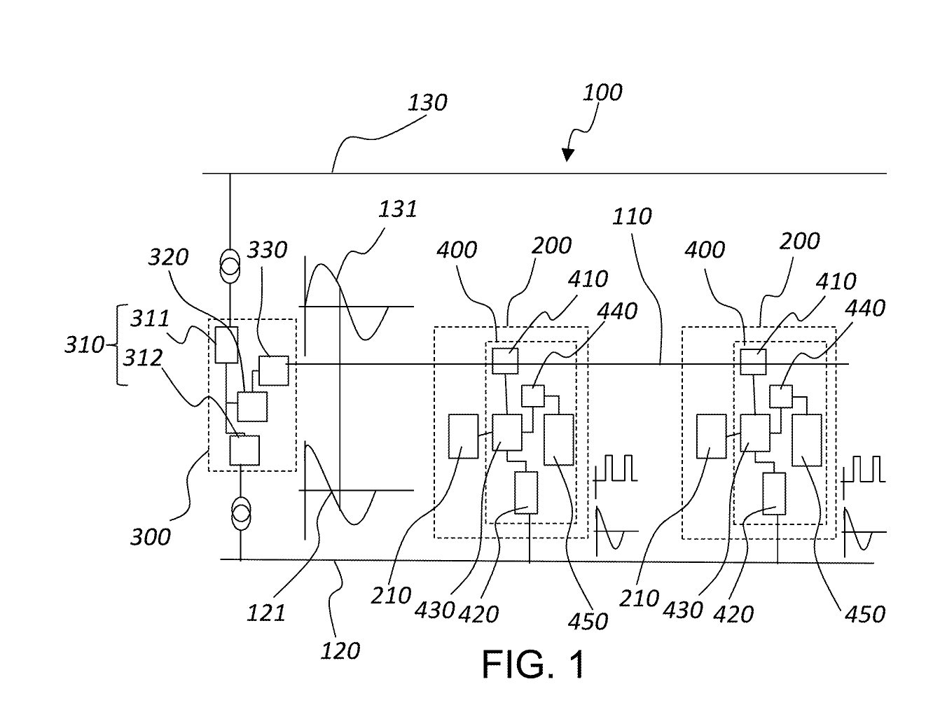

The present invention can be better understood on reading the description of embodiments of the present invention given by way of illustrative and non-limiting example only and with reference to the appended drawing, in which FIG. 1 shows one example of an installation using a synchronization method of the invention.

### DETAILED DESCRIPTION OF PARTICULAR EMBODIMENTS

FIG. 1 shows diagrammatically an example of an installation 100 using a method of synchronizing equipment units 200 connected to a communications network 110.

Such an installation 100 includes:
equipment units 200 for synchronizing with a synchronization voltage, said equipment units 200 being connected to an electrical power supply network 120 and to a communications network 100;
a synchronization module 400 equipping each equipment unit 200 for synchronizing;
a communications network 110; and
a synchronization device 300 connected to the communications network 110, to a synchronization network 130, and to the electrical power supply network 120.

The electrical power supply network 120 provides at least one alternating current power supply voltage 121. This power supply voltage 121 may be an industrial power supply voltage, such as one phase of a single-phase power supply network or one phase of a three-phase power supply network. In this situation, the power supply voltage 121 is a voltage modulated at a frequency substantially equal to 50 hertz (Hz) or 60 Hz for a nominal voltage substantially equal to 220 volts (v) or 110 v.

The communications network 110 is an industrial communications network making communication possible between the various equipment units 200. The communications network 110 preferably uses a communications protocol of the Ethernet type. The communications network 110 may be a cable communications network based on Ethernet cables or optical fibers, a radio-frequency communications network using a Wi-Fi protocol, for example, a power line carrier communications network, or a hybrid solution including a plurality of communication sub-networks using different technologies.

The synchronization network 130 is an electrical network delivering a synchronization voltage 131 to which the equipment units 200 are to be synchronized. The synchronization voltage 131 is an alternating current voltage having a frequency referred to as the synchronization frequency. The synchronization frequency is preferably equal to the frequency of the power supply voltage. According to another option of the invention, the synchronization frequency may be substantially equal to an integer multiple or an integer fraction of the frequency of the power supply voltage.

According to a non-advantageous optional feature of the invention, the synchronization frequency may have any value.

According to one optional feature of the invention, if the synchronization network 130 is a three-phase electrical network the synchronization voltage 131 may be the voltage of one phase of the synchronization network 130.

The synchronization device 300 includes a first measuring system 311 adapted to measure the synchronization voltage 131 and to determine a state of the synchronization voltage 131.

The synchronization device 300 further includes a second measurement system 312 adapted to measure the power supply voltage 121 and to determine a state of the power supply voltage 121.

The first and second measurement systems 311, 312 are adapted to communicate to measure a time difference at the time t between the power supply voltage 121 and the synchronization voltage 131.

According to one optional feature of the invention, the first and second measurement systems 311, 312 may be first and second parts of a synchronous detector circuit for measuring a phase difference between the power supply voltage 121 and the synchronization voltage 131.

For a synchronization voltage 131 having a synchronization frequency identical to the frequency of the power supply voltage 121, the first and second measurement systems 311, 312 are adapted to measure a time difference that reflects a phase difference between the power supply voltage 121 and the synchronization voltage 131.

The first and second measurement systems 311, 312 form time difference measuring means 310.

The synchronization device 300 further includes a computation unit 320 communicating with the first and second measurement systems 311, 312. The computation unit 320 is adapted to compute a computed time difference from the value of the time difference measured by the first and second measurement systems 311, 312. This computed time difference corresponds to the time difference between the power supply voltage 121 and the synchronization voltage 131 the next time the power supply voltage 121 passes through a given state.

According to a first optional feature of the invention, this given state may be the power supply voltage 121 passing through a given value. According to a second optional feature of the invention, this given state may be a predetermined edge of the power supply voltage 121 passing through a given value, which predetermined edge may be the rising edge or the falling edge of the power supply voltage 121.

The computation unit 320 is further adapted to compute a synchronization value from the computed time difference value and the value of the synchronization frequency. This synchronization value may be the computed time difference value, such as a computed value of the phase difference between the power supply voltage 121 and the synchronization voltage 131 when the synchronization frequency is substantially equal to the frequency of the synchronization voltage.

The computation unit 320 forms computation means 320.

The device further includes a communications system 330 adapted to communicate with the communications network 110. The communications system 330 is connected to the computation unit 320 so that the communications system 330 communicates the synchronization value via the communications network 110 to all the synchronization modules 400 of the equipment units 200 for synchronizing.

The communications system 330 may also be adapted to communicate the value of the synchronization frequency to said synchronization modules 400 that do not have the programmed synchronization frequency value if the value of the synchronization frequency is not programmed in at least some of the synchronization modules 400.

Each equipment unit 200 includes a clock 210 for synchronizing, the synchronization module 400 equipping said equipment unit 200 being connected to said clock 210 to enable its synchronization.

Each of the synchronization modules 400 includes means 410 for connecting it to the communications network 110. The communications means 410 may be a communications system independent of the communications system of the equipment units 200 or they may be a connection of the synchronization module 400 to a communications system of the equipment units 200.

Each synchronization module 400 is connected to the electrical power supply network 120 and further includes means 420 for detecting a given state of the power supply voltage. The detection means 420 may be a voltage measurement system 420 enabling detection of the power supply voltage 121 passing through a given value. According to another optional feature of the invention, the voltage measurement system 420 may be adapted to detect the voltage passing through a given value at a predetermined edge, which predetermined edge may be the rising edge or the falling edge of the power supply voltage 121.

The synchronization module 400 further includes a system 430 for synchronizing the equipment unit 200. The synchronization system 430 of the synchronization module 400 communicates with the clock 210 of the equipment unit 200 to synchronize the clock 210 on the basis of the synchronization value and the value of the synchronization frequency. This value of the synchronization frequency is either a pre-programmed value from said synchronization module or a value communicated by the synchronization device 300.

According to one optional feature of the invention the synchronization module 400 may further include a processing unit 440 adapted to compute a desynchronization value reflecting the synchronization error produced when synchronizing the equipment unit 200. This processing unit is further adapted to compare the absolute value of the desynchronization value with the absolute value of a threshold desynchronization value.

According to this optional feature the processing unit may also be adapted to detect another type of synchronization error, such as:
non-reception of the synchronization value;
non-reception of the value of the synchronization frequency if said value is to be communicated to said synchronization module;
loss of the communications network; and
a problem detecting the power supply voltage passing through the given state.

The processor unit 440 forms processor means 440.

According to this same optional feature the module includes a signaling system 450, such as an audible alarm, a display screen or means for sending an error signal to a system for monitoring the installation 100, adapted to cooperate with the processing unit 440 to report when the processing unit 440 computes a desynchronization value the absolute value of which is greater than the absolute value of the threshold desynchronization value or some other type of synchronization error is detected.

According to this optional feature, the signaling system 450 forms signaling means 450.

In operation, such an installation 100 enables synchronization of each of the equipment units 200 equipped with a synchronization module 400 by a synchronization method including the steps of:
a) the synchronization device 300 measuring a time difference between the power supply voltage 121 and the synchronization voltage 131;
b) the synchronization device 300 computing the synchronization value from the time difference, said synchronization value corresponding to a computed time difference between the power supply voltage 121 and the synchronization voltage 131 the next time the power supply voltage 121 passes through a given state;
c) the synchronization device 300 communicating via the communications network 110 a synchronization value to the equipment unit 200 together with the value of the synchronization frequency if the value of the synchronization frequency is not programmed in some of the synchronization modules of the equipment units for synchronizing;
d) the synchronization module 400 equipping each equipment unit 200 detecting the power supply voltage 121 passing through the given state; and
g) each communications module 400 synchronizing the equipment unit 200 that it equips substantially simultaneously with the detection of the power supply voltage 121 passing through the given state from the synchronization value.

According to one optional feature of the invention the synchronization method may include a step a′) that precedes the step a) and consists in the synchronization module 400 detecting the power supply voltage 121 passing through a second given state.

According to this optional feature, the step a) is executed substantially simultaneously with the step a′).

According to the feature of the invention whereby the synchronization module 400 includes a processing unit 440 and a signaling system 450, the synchronization method may further include steps e) of detecting a synchronization error following the step d) and f) of reporting a synchronization problem.

Such a step e) includes the substeps of:
e′) each of the synchronization modules 400 calculating for the equipment unit 200 that it equips a desynchronization value reflecting the synchronization offset necessary to synchronize said equipment unit 200 during the step e); and
e″) each of the synchronization modules 400 comparing the absolute value of the desynchronization value with the absolute value of a threshold desynchronization value and detecting for the equipment unit a synchronization error if the absolute value of the desynchronization value is greater than the absolute value of a desynchronization threshold value.

According to this optional feature, the step e) may also be adapted to detect another type of synchronization error, such as:
non-reception of the synchronization value;
non-reception of the value of the synchronization frequency if said value is to be communicated to said synchronization module;
loss of the communications network; and
a problem detecting the power supply voltage passing through the given state.

The step f) of reporting a problem consists in reporting a desynchronization problem for each equipment unit 200 for which a synchronization error has been detected in the step e).

According to this optional feature, if a synchronization error is detected, the synchronization module 400 is preferably adapted to retain the synchronization preceding the synchronization step in which the synchronization error is detected, to enable correct operation of the equipment unit pending intervention to verify the synchronization module. This is achieved by not executing the step g) if any such synchronization error is detected.

Although in the embodiment described above the synchronization module 400 is an independent synchronization module 400 equipping an equipment unit 200, such a synchronization module 400 or part of said synchronization module 400 may be an integral part of the equipment unit 200, a processing unit of the equipment unit 200 being able to provide the functions of the processing means of the synchronization module 400, for example, without this departing from the scope of the invention.

Similarly, without departing from the scope of the invention, although in the synchronization module 400 of the embodiment of the invention described above the desynchronization value is computed by determining the shift necessary to synchronize the equipment unit 200, that computation may equally be carried out using an internal clock of said synchronization module 400 and comparing the synchronization value with said internal clock.

Similarly, according to one optional feature of the invention not described in relation to the embodiment described above, a given state value may be communicated with the synchronization value, this given state value providing the synchronization module with the given state of the electrical power supply voltage to be detected in the step d) of the method.

According to one optional feature of the invention, the steps e) of detecting a synchronization error and f) of reporting that error may take place substantially simultaneously with the step g) of synchronizing the equipment unit or after that same step g). According to this optional feature, the method then includes a step h) of synchronizing the equipment unit according to a previous synchronization during which no synchronization error was detected.

What is claimed is:

1-13. (canceled)

14. A method of synchronizing an equipment unit connected to a communications network, the equipment unit being connected to an electrical power supply network providing at least one alternating current power supply voltage, wherein the method includes the steps of:
a) measuring a time difference between the power supply voltage and an alternating current synchronization voltage, the synchronization voltage having a synchronization frequency;
b) computing a synchronization value from the time difference, said synchronization value corresponding to a computed time difference between the power supply voltage and the synchronization voltage a time that is the next time the power supply voltage will pass through a given state;
c) communicating the synchronization value to the equipment unit via the communications network;
d) the equipment unit detecting the power supply voltage passing through the given state; and
g) synchronizing the equipment unit substantially simultaneously with detecting the power supply voltage passing through the given state from the synchronization value.

15. A synchronization method according to claim 14, wherein the value of the synchronization frequency is also communicated to the equipment unit during the step c) of communicating the synchronization value.

16. A synchronization method according to claim 14, wherein the given state of the power supply voltage is a given voltage value that is preferably equal to zero volts.

17. A synchronization method according to claim 14, wherein the given state of the power supply voltage is a predetermined edge of the power supply voltage passing through a given value, the predetermined edge being chosen from the group comprising the rising edge and the falling edge.

18. A synchronization method according to claim 14, wherein the method further includes, preceding the step a), a step a′) of detecting the power supply voltage passing through a second given state, the step a) being carried out substantially simultaneously with the step a′).

19. A synchronization method according to claim 18, wherein the second given state of the power supply voltage is such that all the steps a) to c) are carried out before the power supply voltage next passes through the given state.

20. A synchronization method according to claim 14, wherein the method further includes, between the steps d) and g), the steps of:
e) detecting an equipment unit synchronization error; and
f) reporting a desynchronization problem affecting the equipment unit if a synchronization error is detected.

21. A synchronization method according to claim 20, wherein the step e) includes at least the sub-steps of:
e′) computing for the equipment unit a desynchronization value reflecting the synchronization offset necessary to synchronize said equipment unit during the step e); and
e″) comparing the absolute value of the desynchronization value with the absolute value of a desynchronization threshold value and detecting a desynchronization error affecting the equipment unit if the absolute value of the desynchronization value is greater than the absolute value of the desynchronization threshold value.

22. A synchronization method according to claim 14, wherein the communications network is a communications network utilizing a protocol of the Ethernet type.

23. A synchronization method according to claim 14, wherein the frequency of the synchronization voltage is substantially equal to, an integer multiple of, or an integer fraction of the frequency of the power supply voltage, the frequency of the synchronization voltage preferably being equal to the frequency of the power supply voltage.

24. A synchronization device for synchronizing an equipment unit, said synchronization device being connected to an electrical power supply network providing at least one alternating current power supply voltage, wherein the synchronization device comprises:
time difference measurement means adapted to measure a time difference between the power supply voltage and a synchronization voltage;
computation means adapted to compute a synchronization value corresponding to a time difference; and
communications means adapted to be connected to a communications network and to communicate a synchronization value via said communications network.

25. A synchronization module for equipping an equipment unit for synchronizing, said synchronization module being connected to an electrical power supply network providing at least one alternating current power supply voltage, wherein the synchronization module includes:
means for connecting it to a communications network and adapted to receive a synchronization value;
means for detecting a given state of the power supply voltage; and
means for synchronizing the equipment unit on the basis of the synchronization value communicated via the communications network.

26. A synchronization module according to claim 25, wherein the synchronization module further includes:
processing means adapted to detect a synchronization error;
signaling means adapted to report a desynchronization problem affecting said synchronization module; and
the processing means being further adapted to communicate with said signaling means to report a synchronization problem on detecting a synchronization error.
